(19) United States
(12) Patent Application Publication
(10) Pub. No.: US 2008/0264935 A1
(43) Pub. Date: Oct. 30, 2008

(54) Platter

(76) Inventors: Stephen Graham Rutherford, Hertfordshire (GB); James Harold Johns, Bedfordshire (GB)

Correspondence Address: STETINA BRUNDA GARRED & BRUCKER, 75 ENTERPRISE, SUITE 250, ALISO VIEJO, CA, 92656, US

(21) Appl. No.: 10/574,164

(22) PCT Filed: Sep. 29, 2004
(86) PCT No.: PCT/GB2004/004113

§ 371 Date: May 30, 2006

(30) Foreign Application Priority Data
Sep. 29, 2003 (GB) 0322740.2
Oct. 30, 2003 (GB) 0325294.7
Jun. 16, 2004 (GB) 0413471.4

(51) Int. Cl. H05B 6/80; H05B 6/64; A23L 1/01

(52) U.S. Cl. 219/732; 219/756; 426/243

(57) ABSTRACT

A platter for use in a forced air/microwave combination oven, the platter comprising an upper surface and a lower surface and incorporating a plurality of apertures passing through the thickness of the platter; wherein one or both of the surfaces of the platter incorporate a recess substantially surrounding at least one of the apertures. The invention also provides a platter incorporating an indentation shaped to receive an item of cookware, the indentation being positioned to align the cookware with microwave radiation in the oven in use. Additionally, the invention provides a platter incorporating apertures distributed over substantially the entire surface area of the platter, and also a platter comprising a central region substantially devoid of apertures, and one or more apertures at substantially the edge of the platter. Preferably the platter is made of a polymer material, particularly preferably a liquid crystal polymer resin such as DuPont (RTM) Zenite (RTM) 7130. Also provided is a method of cooking using such a platter.

### CROSS-REFERENCE TO RELATED APPLICATIONS

Not Applicable

### STATEMENT RE

### Federally Sponsored Research/Development

Not Applicable

### BACKGROUND

Forced air/microwave combination ovens are in common usage, and one popular model is the TurboChef C3 oven, supplied by TurboChef Technologies, Inc., of 10500 Metric Drive, Suite 128, Dallas, Tex. 75243, USA. Such ovens are typically found in petrol stations, motorway service area cafeterias and roadside restaurants, and are used for cooking or defrosting a wide range of foods such as pizzas, hot filled baguettes, lasagne, steak, fish, burgers and pies. The ovens use a combination of rapidly-moving electrically-heated hot air and microwave radiation, and will be referred to herein as forced air/microwave combination ovens. The TurboChef C3 can reach a cooking temperature of 275° C., and cooks on average at seven times the speed of a conventional oven. The microwave generator is located beneath the oven chamber, and transmits microwave radiation via a waveguide up into the oven chamber. The forced air is delivered from above, into the top of the oven chamber, and is extracted from the bottom of the chamber, beneath the platter. The microwave and hot air modes of cooking food may be used independently or together, and the oven is processor-controlled to run a range of cooking routines using the different cooking modes.

The platter of a forced air/microwave combination oven is located towards the bottom of the cooking chamber, above the microwave generator and microwave waveguide cap. The platter is essentially a shelf on which cookware is placed, the cookware containing the food to be cooked. The platter contains holes through which forced air passes, and is also microwave-permeable to enable microwave radiation to reach food placed on the platter. Traditionally, such platters are made from a porous ceramic material, and several disadvantages, shortcomings and problems have been identified, as follows:

1. Desire for Greater Cooking Efficiency Using Forced Air

There is a desire to improve the efficiency of cooking using forced air, and also to reduce the frequency with which high temperature thermal cutout devices trip during service. This in turn would give rise to faster cooking times and more efficient use of energy. The current forced air cooking performance of such ovens, and the frequency with which the cutout devices trip, is thought to be influenced by the number and distribution of the apertures through the platter. Traditional ceramic platters have a somewhat irregular distribution of apertures, and there are areas in which relatively few apertures are provided. This is thought to limit the airflow and may give rise to undesirable thermal cutout trips in service. The limited number and irregular distribution of the apertures in traditional platters is thought to be because the ceramic material would be more liable to fracture if more apertures were provided.

Enhanced flow of hot air around and under the cookware on the platter is also desired, to improve the cooking performance yet further.

2. Risk of Incomplete Cooking by Microwaves Alone

Although the apertures are distributed across much of the area of a conventional ceramic platter, the microwave radiation used in the oven is concentrated in a specific area in the centre of the platter. Traditionally, the user has been free to position the food product anywhere on the platter. However, it will be appreciated that if the food product is to be cooked only by microwave radiation, and not by hot air, then placement of the food off-centre on the platter can result in it not being adequately cooked.

3. Handling and Cleaning Problems

A forced air/microwave combination oven may be in almost continuous use throughout the day, particularly in motorway service areas and the like which are frequented by customers at all hours. Given the nature of the food products that are prepared, the platter can readily become unclean, particularly from cheese and other molten materials that fall from the cookware and become burnt onto the platter. In a catering environment, food hygiene and cleanliness are of paramount importance, and so the staff that operate the ovens are required to clean them regularly.

Traditionally, platters used in such ovens are made from a porous ceramic material, and chip easily when being cleaned, due to the inherent brittleness of the ceramic material. Cleaning staff may not be particularly careful when carrying out their job, and this increases the likelihood of chipping or breakage of the ceramic platters. Also, because of their porosity, conventional platters cannot be soaked during cleaning, as this would result in the platter taking in water through the network of pores inherent in the material. Thus, it will be appreciated that cleaning off the burnt on food products can be very difficult and time consuming to do properly, without soaking the platter. An unconscientious worker may well soak the platter, contrary to instructions, or may simply not clean the platter thoroughly.

A further problem is that, during cooking, food may fall through the platter and onto the waveguide cap, or elsewhere on the base of the oven chamber beneath the platter. Given the nature of the food products that are prepared, this area underneath the platter can readily become unclean, particularly from cheese and other molten materials that fall through the platter and become burnt. In a catering environment, food hygiene and cleanliness are of paramount importance, and so the staff that operate the ovens are regularly required to clean this area under the platter.

To clean the base of the oven chamber requires the oven to be turned off, during which time it could otherwise be used to prepare food for customers. Also, cleaning the base of the oven chamber requires the cleaning operative to work with their hands and arms inside the oven chamber, which is a confined space and may be hot.

### BRIEF SUMMARY

According to a first aspect of the invention there is provided a platter for use in a forced air/microwave combination oven, the platter comprising an upper surface and a lower surface and incorporating a plurality of apertures passing through the thickness of the platter; wherein one or both of the surfaces of the platter incorporate a recess substantially surrounding at least one of the apertures.

The term “aperture” as used herein should be interpreted broadly, to encompass holes, slits, slots and other types of openings. Thus, the term “aperture” is intended to encompass both a hole passing through a platter, and an open region in an edge of a platter that passes through the thickness of the platter.

The provision of recesses around the apertures advantageously promotes the flow of air under cookware placed on the platter.

In a first embodiment, the upper surface is profiled such that each aperture is substantially surrounded by an individual recess.

Preferably the recess tapers outwards towards the upper surface. This reduces contact between the cookware and the platter, which can facilitate removal of the cookware if the platter is dirty.

Particularly preferably adjacent tapering recesses meet at common points on the upper surface of the platter, thereby minimising contact between the cookware and the platter, and further facilitating removal of the cookware if the platter is dirty.

In a second embodiment, the apertures are arranged in an array of rows and columns, and the upper surface is profiled such that a plurality of apertures in a row are together surrounded by an elongate recess extending along said row. The elongate recess may taper outwards towards the upper surface. Such elongate recesses advantageously retain baguettes and long rolls placed directly on the platter, and also provide long unobstructed channels for airflow under the cookware.

Preferably the lower surface is profiled such that a plurality of apertures in a column are together substantially surrounded by an elongate recess extending along said column. The elongate recess may taper outwards towards the lower surface. This arrangement advantageously provides strength and flexural rigidity to the platter, and prevents undesirable flexing in use.

Either embodiment may optionally further incorporate an indentation shaped to receive an item of cookware, the indentation being positioned to align the cookware with microwave radiation in the oven in use. This advantageously ensures that food in cookware placed in the indentation is optimally exposed to microwave radiation, which is particularly important if only microwaving (and not hot air) is being used in a given cooking program.

The term “indentation” as used in this context should be interpreted broadly, to encompass any change in surface profile adapted to receive an item of cookware. Thus, an annulus or other protrusions that rise from the surface of the platter and which are adapted to receive an item of cookware, function in essentially the same way as an indentation and should be treated as such.

With either embodiment, the apertures may be distributed over substantially the entire surface area of the platter. This promotes airflow around the oven and provides a more extensive cooking area, and is also less likely to impede the flow of hot air which can often be the cause of the oven cutting out or tripping.

According to a second aspect of the invention there is provided a platter for use in an oven, the platter comprising: a central region substantially devoid of apertures, and one or more apertures at substantially the edge of the platter, said one or more apertures passing through the thickness of the platter.

By providing a central region substantially devoid of apertures, and by positioning the apertures at substantially the edge of the platter, this provides the advantage that food matter is prevented or at least impeded from passing through the holes in the aperture and onto the base of the oven chamber. A dirty platter may be quickly taken out and replaced by a clean one, thereby enabling a commercial oven to continue being used without needing to spend time cleaning the base of the oven chamber.

Preferably said one or more apertures are positioned at the edge of the platter and are open-sided. Particularly preferably the platter further comprises one or more raised edge members around the perimeter of the platter for retaining food debris in use. By positioning open-sided apertures at the edge of the platter, a raised edge member may be provided around the entire perimeter of the platter, thereby minimising the likelihood of food debris falling onto the base of the oven chamber during cooking.

The platter may further comprise means for attaching a handle, or handle means.

With both the first and second aspects of the invention, preferably the platter is made of a polymer material, particularly preferably a liquid crystal polymer resin reinforced with glass, such as DuPont (RTM) Zenite (RTM) 7130. Advantageously, such materials are easy to clean and may be soaked in water without detriment.

According to a third aspect of the invention there is provided a platter for use in a forced air/microwave combination oven, wherein the platter incorporates an indentation shaped to receive an item of cookware, the indentation being positioned to align the cookware with microwave radiation in the oven in use.

According to a fourth aspect of the invention there is provided a platter for use in a forced air/microwave combination oven, the platter incorporating apertures distributed over substantially the entire surface area of the platter.

According to a fifth aspect of the invention there is provided a platter for use in an oven, the platter being made of a polymer material. Preferably the polymer material is a liquid crystal polymer resin reinforced with glass. Particularly preferably the platter is made of DuPont (RTM) Zenite (RTM) 7130.

According to a sixth aspect of the invention there is provided a platter having a first major surface and a second major surface, the surface area of the first major surface being greater than that of the second major surface so as to concentrate heat flux from the first major surface to the second major surface in use.

According to a seventh aspect of the invention there is provided an oven having a platter in accordance with any of the first, second, third, fourth, fifth or sixth aspects of the invention.

According to an eighth aspect of the invention there is provided a method of cooking using an oven having a platter in accordance with any of the first, second, third, fourth or fifth aspects of the invention.

### BRIEF DESCRIPTION OF THE DRAWINGS

Embodiments of the invention will now be described, by way of example, and with reference to the drawings in which:

FIG. 1 illustrates a forced air/microwave combination oven, indicating the position of the microwave waveguide and platter in use, and showing a prior art platter;

FIG. 2 illustrates a first embodiment of an improved platter;

FIG. 3 shows a close-up view of part of a platter in accordance with the first embodiment;

FIG. 4 shows a variant of the first embodiment;

FIG. 5 illustrates plan and side elevations of a second embodiment of an improved platter, without a central indentation;

FIG. 6 illustrates plan and side elevations of the second embodiment, with a central indentation to receive an item of cookware in use, and example dimensions;

FIG. 7 illustrates plan and side elevations of a third embodiment of a platter, also with example dimensions;

FIG. 8 illustrates a plan view from above of a platter having a plurality of apertures in the central region, and incorporating a plurality of diagonal ridges on the upper surface;

FIG. 9 illustrates a plan view from above of a platter having a plurality of apertures in the central region, and incorporating a plurality of parallel ridges on the upper surface;

FIG. 10 illustrates views of a platter having a plurality of apertures in the central region, a larger open-sided aperture at each end, and incorporating a plurality of parallel ridges on the upper surface;

FIG. 11a illustrates the cross section of a platter having a flat upper surface and a ridged under surface;

FIG. 11b illustrates heat flux through the platter of FIG. 11a, in the locality of a ridge; and

FIG. 11c illustrates an alternative cross section to that of FIG. 11a, being more convoluted to increase the surface area of the under surface.

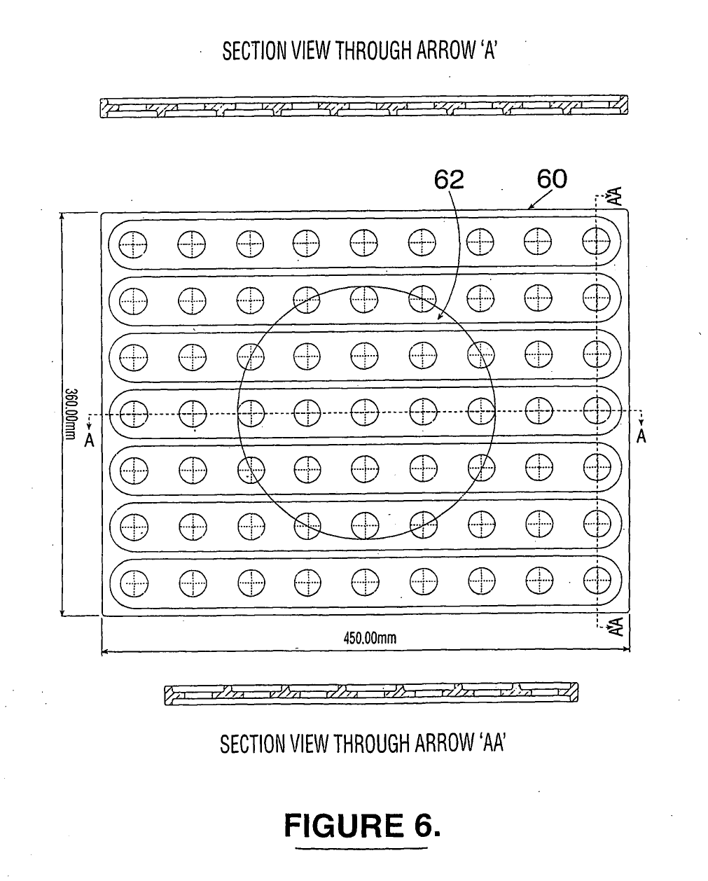

The dimensions in FIGS. 6, 7, 8, 9 and 10 are provided by way of example only, as the products may be made in a variety of shapes and sizes.

### DETAILED DESCRIPTION

The present embodiments represent the best ways known to the applicant of putting the invention into practice. However they are not the only ways in which this can be achieved.

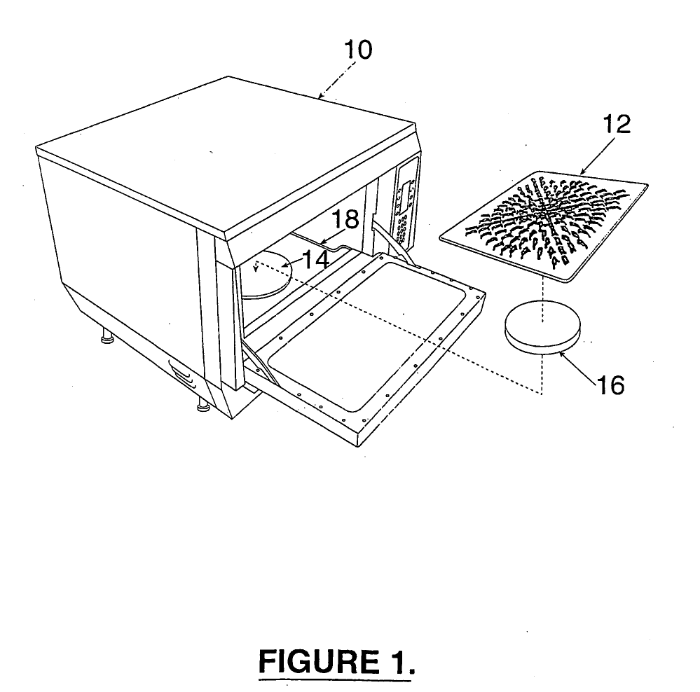

By way of background, FIG. 1 shows an example of a TurboChef C3 forced air/microwave combination oven 10. The oven measures approximately 550 mm high, 740 mm wide, and 820 mm from front to back. The microwave waveguide 14 is situated at the base of the cooking chamber, and is covered by a waveguide cap 16. The platter 12 is then located on a pair of support rails 18, above the waveguide cap.

Traditional platters are made from porous ceramic material, and consequently cannot readily be formed into intricate shapes. As FIG. 1 shows, a traditional platter 12 is essentially a flat plate having a number of protrusions rising from the upper surface to support an article of cookware placed thereon. The protrusions are elongated with flat tops, and radiate from the centre of the platter. Some apertures are provided between the protrusions in the central region of the platter.

The embodiments of the invention that will now be described are presently preferably made from DuPont (RTM) Zenite (RTM) 7130, a liquid crystal polymer resin reinforced with 30% glass that is able to withstand temperatures of up to 289° C., which is well in excess of the maximum operating temperature of the TurboChef C3 oven. Alternatively, Zenite (RTM) 7145 may be used, which is able to withstand temperatures up to 303° C. These Zenite (RTM) materials are well suited to injection moulding, thereby enabling the intricate shapes of platters described herein to be readily formed. Highly advantageously, and in marked contrast to traditional porous ceramic platters, a resin platter can easily be cleaned without risk of brittle failure or chipping, and can be soaked in water without detriment. This enables better hygiene and levels of cleanliness to be maintained.

Other materials suitable for use in a forced air/microwave combination oven may be used instead of DuPont (RTM) Zenite (RTM), and the present disclosure is intended to apply to and encompass all suitable materials already in existence and those which have yet to be discovered or developed, such as advanced engineering polymers, glasses, ceramics and composite materials. For example, DuPont (RTM) Thermx (RTM), a high performance polyester, may be used as an alternative to Zenite (RTM).

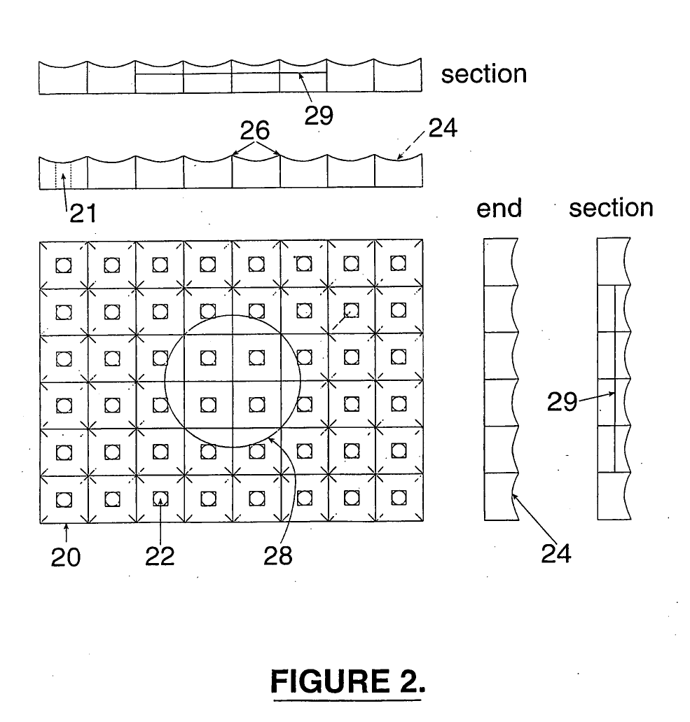

Turning now to a first embodiment of the invention, FIG. 2 shows a platter 20 incorporating an extensive array of holes or apertures 21, 22 passing through the thickness of the platter. The provision of an array of apertures as shown in FIG. 2 is to be contrasted with the limited number of apertures provided in a traditional ceramic platter. It is believed that an extensive array of apertures as shown in FIG. 2 would not be favoured with a traditional ceramic platter, since such an array would be likely to promote fracture of the ceramic platter, with the array of holes behaving effectively as perforations and defining lines along which the platter would readily break. With the use of an engineering polymer, however, such an array may be readily formed and the platter is not prone to brittle fracture.

The apertures in the platter enable forced hot air to pass through during cooking. By providing a more extensive array of apertures than in traditional platters, the present embodiment of the invention provides a more extensive cooking area through which the hot air passes, and is also less likely to impede the flow of hot air, which can often be the cause of the oven cutting out or tripping.

The upper surface of the platter 20 is profiled such that the majority of apertures are each located within an individual recess 24. These recesses taper upwardly outwards, from the edge of each aperture, to join the upper surface of the platter. As shown in FIG. 2, these tapers preferably meet at common points 26. Items of cookware are then supported on the pointed crests 26. This undulating surface profile provides a number of benefits and advantages to the performance of the oven. Firstly, by placing flat-bottomed cookware on the pointed crests 26, horizontal channels are formed between the underside of the cookware and the upper surface of the platter. Hot air can pass along these channels during cooking, and an array of channels such as this provides better overall circulation of hot air around the cookware. Secondly, this arrangement minimises contact between the cookware and the platter, thereby facilitating the removal of the cookware if the platter is dirty (e.g. with gooey cheese).

Not all the apertures need be surrounded by recesses.

The apertures may be recessed on the upper surface of the platter only, or on the lower surface of the platter only, or on both the upper and lower surfaces of the platter.

In the embodiment shown in FIG. 2, an optional indentation 28 is formed in the centre of the upper surface of the platter. Within the indentation 28, its upper surface 29 is flat. This indentation is positioned such that an article of cookware placed therein is positioned in the optimum area in the oven chamber for microwave cooking, i.e. above the outlet of the waveguide. The indentation 28 may be circular, as shown in FIG. 2, although other shapes such as squares and rectangles are also possible. Articles of cookware may advantageously be shaped to locate within the indentation 28. If the cooking program for a particular item of food only uses microwave cooking, then the user could be instructed to use such an article of cookware (e.g. by colour coding the cookware in correspondence with the cooking program) and to locate it in the indentation. This then ensures that the food is placed in the optimum position for microwave cooking, and the user does not place it over to one side on the platter where exposure to the microwave radiation would be less effective.

If the positioning of food is not critical, e.g. because both hot air and microwaves are being used, then an article of cookware larger than the indentation may be used, to span the indentation. Alternatively, the cookware may be placed on the platter aside from the indentation.

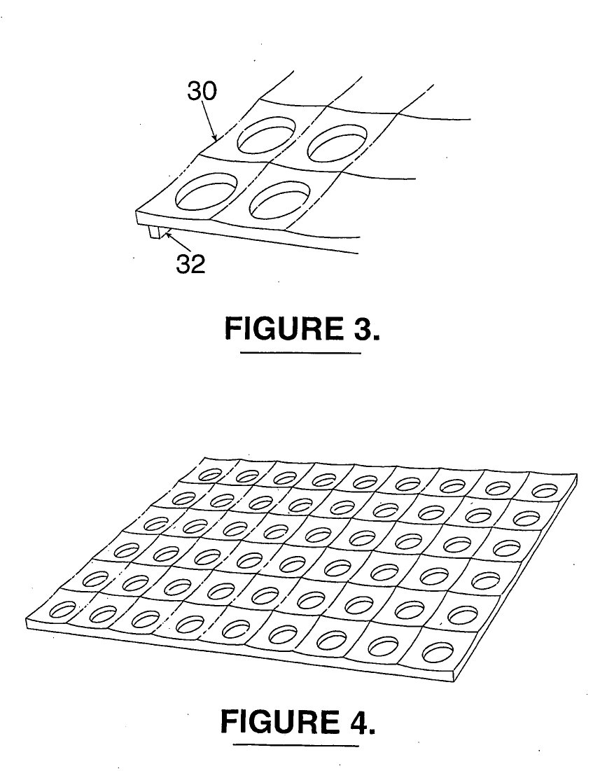

FIG. 3 shows a close-up view of part of a platter 30 that is broadly the same as that shown in FIG. 2. The horizontal member 32 is optional. This figure clearly shows the undulating upper surface of the platter and the recesses around the apertures.

FIG. 4 shows a variant of the embodiment shown in FIGS. 2 and 3.

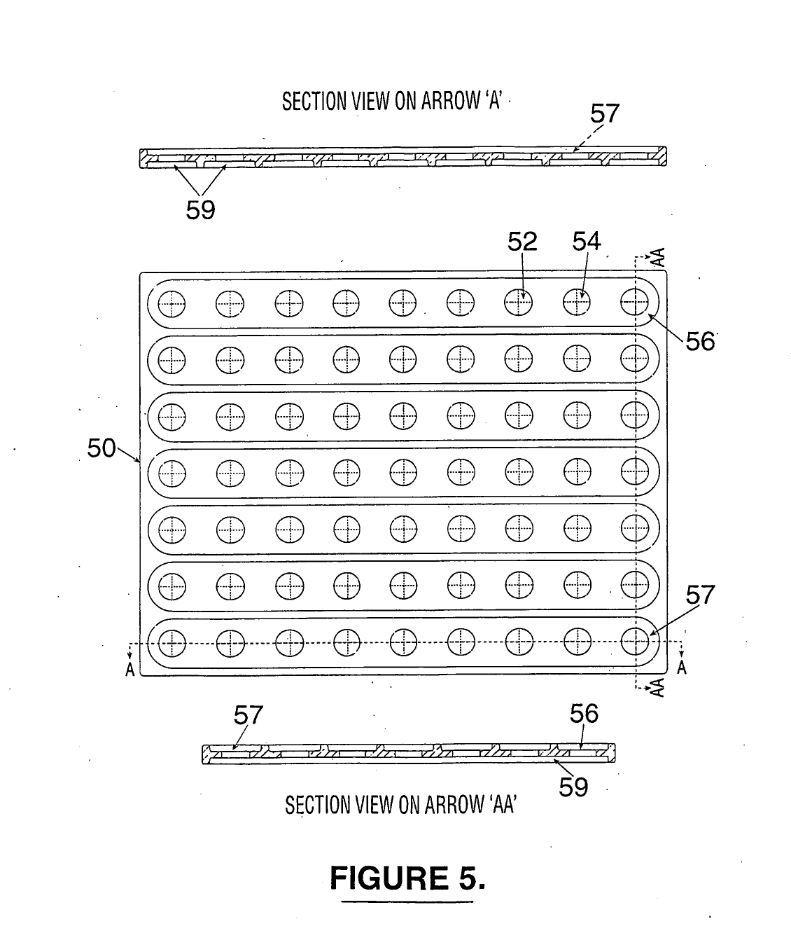

FIG. 5 illustrates a second embodiment of a platter 50. Here, the apertures are arranged in an array of rows and columns. The apertures that form a row (e.g. 52, 54) are together surrounded by elongate recesses 56, 57 extending along the row on the upper surface of the platter. Such elongate recesses provide specific advantages. Firstly, they retain baguettes and long rolls that are placed directly on the platter, and prevent them from rolling around. Secondly, when cookware is placed on the platter, the elongate recesses form long unobstructed channels between the platter and the underside of the cookware, which promote the circulation of hot air within the oven.

The lower surface (underneath) of the platter is also profiled to incorporate elongate recesses surrounding a plurality of apertures, but these recesses 59 run at 90° to those on the upper surface. That is to say, whilst the recesses 56, 57 on the upper surface extend along rows of apertures, the recesses 59 on the lower surface extend along columns of apertures. This arrangement has been found to provide strength and flexural rigidity to the platter, and prevents undesirable flexing in use. It has also been found to prevent distortion of the platter during injection moulding, when being manufactured.

In this embodiment, the elongate recesses taper outwards towards the outer surfaces of the platter.

FIG. 6 illustrates a variant of the platter of FIG. 5. This platter 60 incorporates a central indentation 62 to receive an item of cookware to ensure it is placed in an optimum position for microwaving, as previously discussed with respect to FIG. 1.

A platter may incorporate one or more vertically-extending members, to enable a plurality of platters to be stacked in use. Such a capability is particularly useful when cooking baguettes or rolls. Accordingly, one variant of the platter of FIG. 5 includes vertically-extending members positioned around the edge of the platter, to enable a plurality of platters to be stacked. Another variant incorporates raised ridges between adjacent rows of apertures. The size and number of apertures in the platter, and the width of the elongate recesses (e.g. 56, 57) extending along the rows of apertures, may be varied to suit the cooking of different foodstuffs.

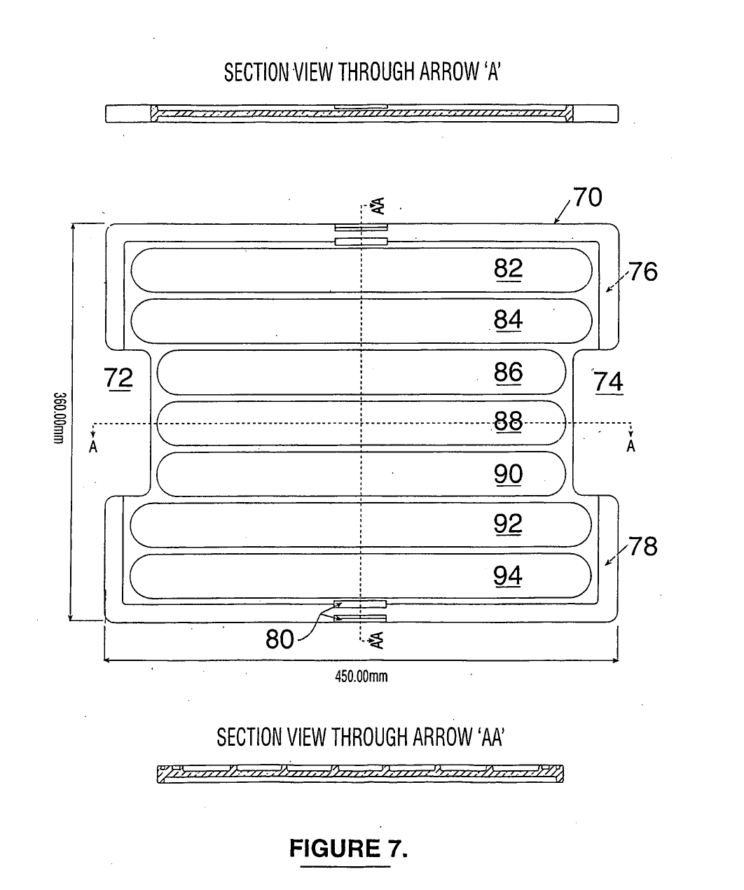

FIG. 7 illustrates a platter 70 having no apertures in the central region, and a relatively large aperture 72, 74 on either side. It has been found that a sufficiently large aperture 72, 74 on either side of the platter enables the flow of hot air to pass through the oven chamber without any appreciable detriment to the cooking performance of the oven. This enables the central region of the platter to be devoid of apertures, thereby preventing food matter from falling though onto the base of the oven chamber.

The large apertures 72, 74 may alternatively be provided in the corners of the platter, although this is presently less preferred.

A raised rim 76, 78 extends around much of the perimeter of the platter, to retain food debris in use. The rim may extend around the entire of the edge of the platter (including the inner edge of the apertures 72, 74), thereby retaining substantially all the food debris that may fall.

In the embodiment shown in FIG. 7, the platter 70 incorporates a plurality of recessed regions 82, 84, 86, 88, 90, 92 and 94, which serve to retain baguettes and rolls, and also provide pathways for the flow of air under items placed on the platter. These recessed regions are optional, and for some applications it may be desirable for the central region of the platter to be flat.

The platter 70 incorporates means 80 by which a handle may be attached to the platter.

The design illustrated in FIG. 7 is particularly suitable for injection-moulding. Since this platter does not incorporate holes, the polymer flow is not required to diverge and then re-converge during the moulding procedure, and hence the platter may be moulded without the formation of glassy join lines that may otherwise be formed when moulding an article that contains holes.

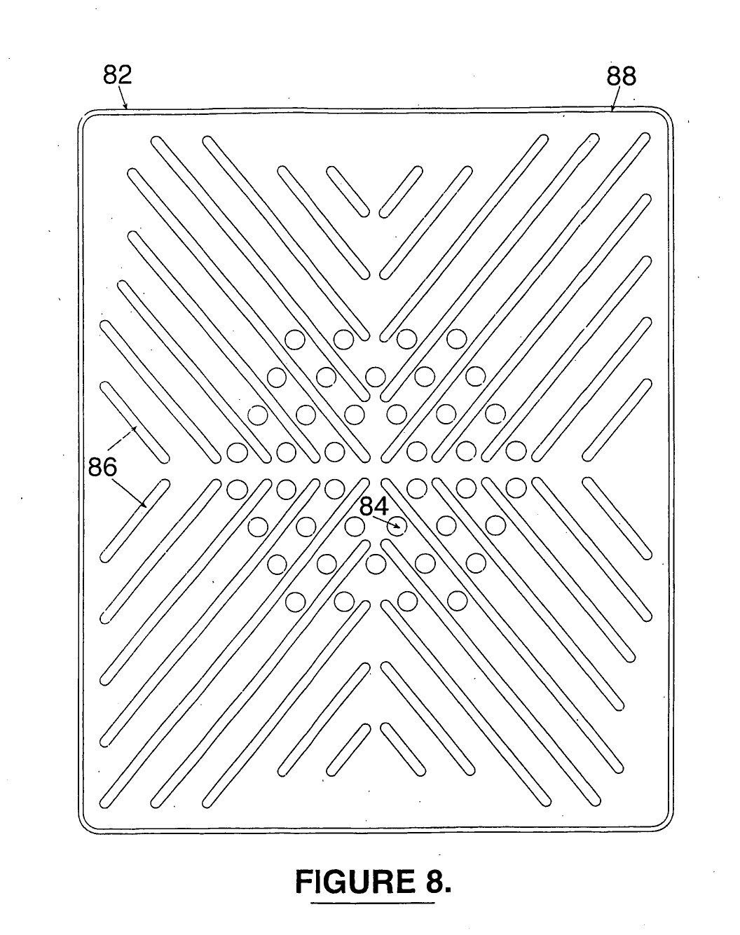

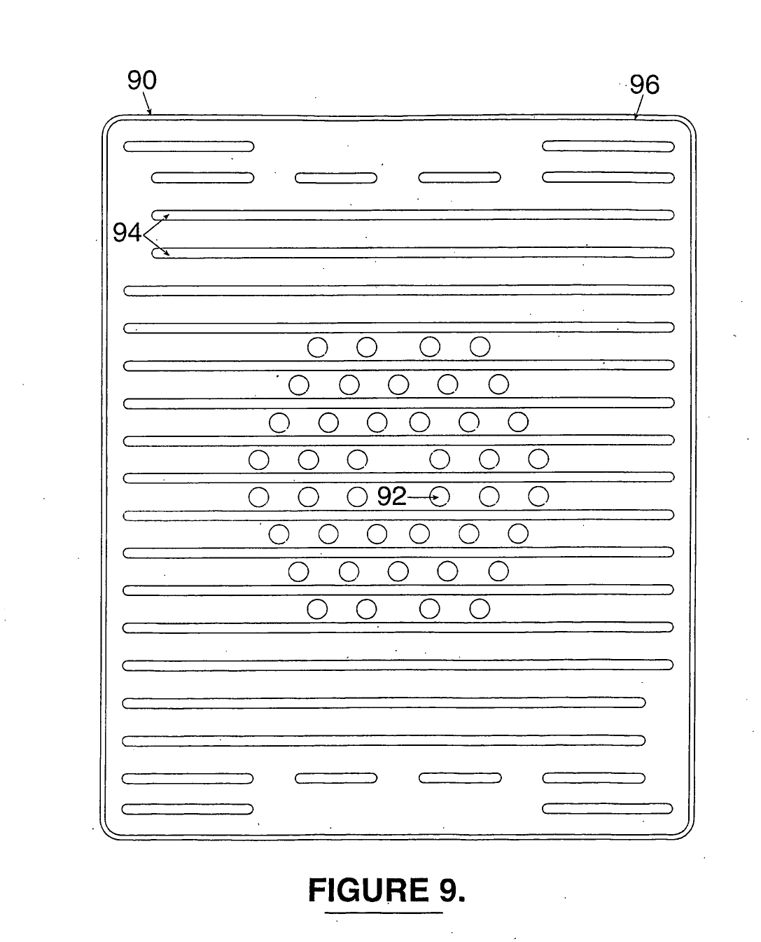

FIGS. 8 and 9 illustrate plan views of further embodiments of platters 82, 90. Each platter 82, 90 has a flat underside (not illustrated), although in alternative embodiments the underside may also incorporate ridges or recesses. Indeed, providing ridges on both sides of the platter may provide enhanced rigidity and reduced distortion during moulding.

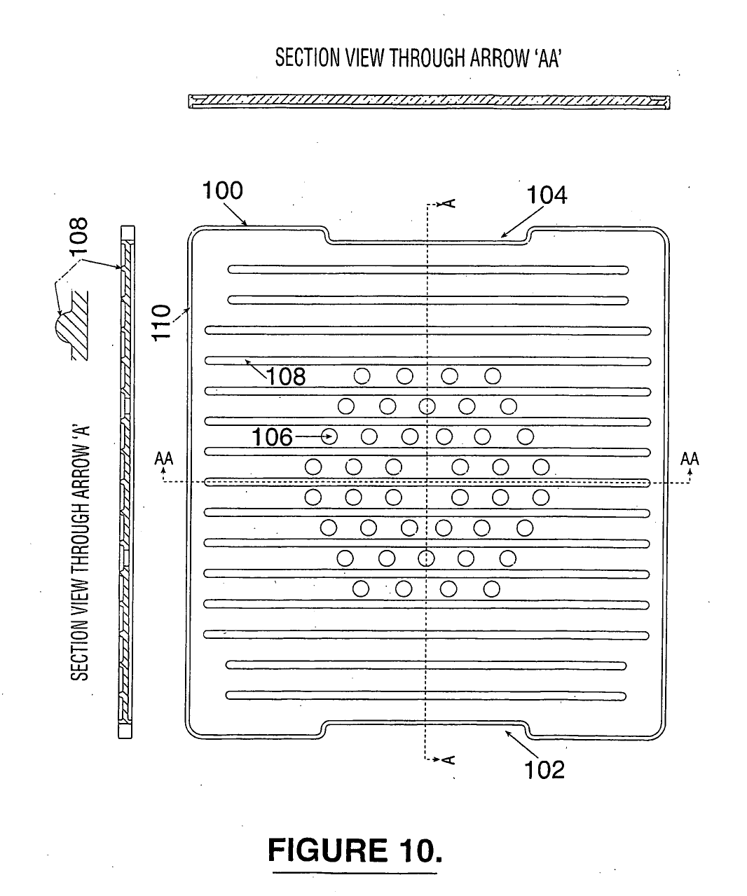

A plurality of apertures 84, 92 are provided in the central region of each of the platters 82, 90, with each aperture passing through the thickness of the platter. Alternatively, or in addition, apertures may be incorporated elsewhere in each platter. (An example is illustrated in FIG. 10, in which platter 100 incorporates edge apertures 102, 104 in addition to central apertures 106.)

Additionally, the upper surface of each platter 82, 90 also incorporates a plurality of ridges 86, 94. Each ridge is approximately 3 mm high and is substantially semicircular in cross-section. Higher ridges may alternatively be employed, for example to prevent rolls and similar food products from rolling or moving during the cook cycle. As illustrated, some of the ridges 86, 94 pass between some of the apertures 86, 94, effectively resulting in the apertures being recessed relative to the uppermost surface of the ridges 86, 94. Other ridges are provided aside from the region of the platter in which apertures are incorporated. The ridges may extend in a diagonal configuration as shown in FIG. 8, or in a parallel configuration as shown in FIG. 9. Other configurations and arrangements of ridges are possible. In one embodiment, the platter may have the arrangement of ridges of FIG. 8 on one surface (e.g. the top surface), and the arrangement of ridges of FIG. 9 on the other surface (e.g. the underside).

Each platter 82, 90 also incorporates a raised rim 88, 96, substantially the same height as the ridges.

The arrangement of the ridges and apertures shown in FIGS. 8 and 9 enable an article of cookware to be supported on the ridges, above the apertures. Thus, hot air may flow through the apertures and around the underside of the article to cook food contained on or within the cookware.

FIG. 10 illustrates a platter 100 which incorporates a pair of edge apertures 102, 104 and a plurality of central apertures 106. The platter 100 also incorporates a plurality of ridges 108 on its upper surface. In this embodiment the under surface is flat, although the under surface may optionally incorporate ridges too, or instead of the upper surface. A rim 110 extends around the perimeter of the platter 100.

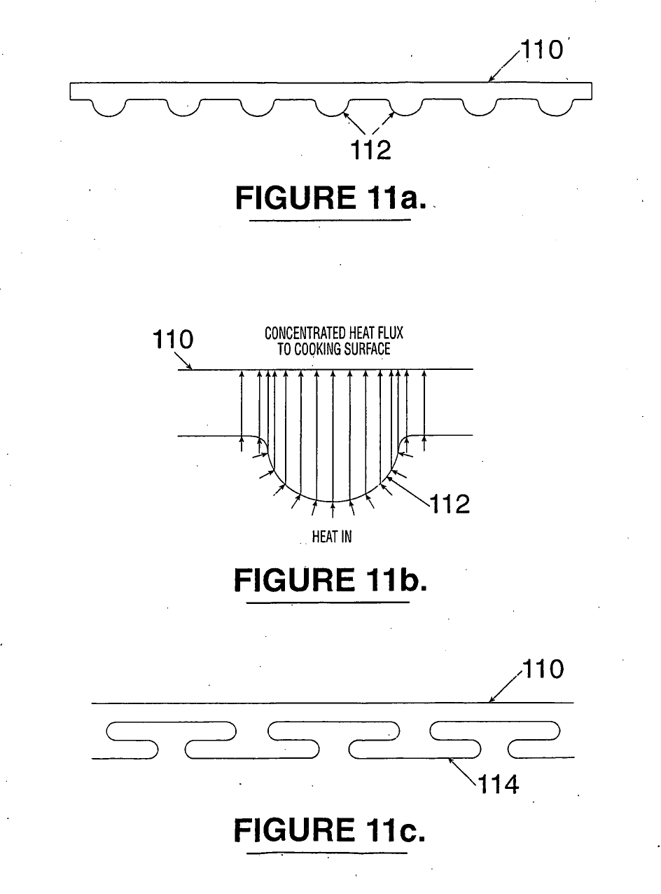

An alternative embodiment of a platter, as illustrated schematically in cross section in FIGS. 11a and 11b, incorporates no central apertures (although central apertures may be incorporated if desired), and has one substantially flat major surface 110 and one major surface which incorporates ridges 112. Edge apertures may optionally be provided to allow hot air to circulate within the oven.

This platter is reversible and may be used either way up. With the flat surface 110 uppermost, it has been found that this platter is well suited to the cooking of foodstuffs such as pasties, pizzas and pastries, which may be placed directly on the flat upper surface during cooking. It is considered that the highly effective cooking performance of this platter is partly due to the underside (which incorporates the ridges 112) having a greater surface area than the flat upper surface 110. With the underside being heated, the heat flux density (i.e. the quantity of heat per unit area) being conducted through the platter becomes concentrated as it reaches the flat upper surface and the food. This may be visualised by imagining lines of heat flux passing through the platter, as illustrated in FIG. 11b. These flux lines have a lower flux density on the surface incorporating the ridges 112 (and consequently having the greater surface area), and a higher flux density as they meet the flat upper surface 110. Thus, the flux lines become more concentrated as they pass through the platter, and this gives rise to enhanced cooking of the food.

This effect may be further enhanced by further increasing the surface area of the underside of the platter, for example by creating a convoluted structure as illustrated in cross section in FIG. 11c.

Although the platters described above have been described with respect to their use in commercial ovens (particularly forced air/microwave combination ovens), they are suitable for use in other types of ovens, including domestic and industrial ovens (including gas, electric, microwave and combination ovens).

Test Results

A platter as described herein was used in conjunction with an article of cookware as described in our co-pending patent application entitled “Improved Cookware”, to cook frozen pizza in a TurboChef C3 oven. The conventional cooking time for frozen pizza with this oven is 2.5 minutes. Remarkably, using a platter as described herein, and without changing the cooking temperature, the cooking time was reduced to 1.5 minutes, saving 40% of the conventional cooking time. Thus, not only is the cooking process substantially expedited, but energy is also saved by virtue of the oven being operational for less time.

1-38. (canceled)

39. A platter for use in an oven, the platter comprising one or more apertures at substantially the edge of the platter, said one or more apertures passing through the thickness of the platter.

40. A platter as claimed in claim 39, having a central region that is substantially devoid of apertures.

41. A platter as claimed in claim 40, wherein the said one or more apertures are positioned at the edge of the platter and are open-sided.

42. A platter as claimed in claim 41, wherein the upper surface of the platter comprises a plurality of vertically-extending members.

43. A platter as claimed in claim 42, wherein the vertically-extending members are in the form of ridges.

44. A platter as claimed in claim 43, wherein the said ridges are parallel.

45. A platter as claimed in claim 44, wherein the said ridges extend over substantially the entire width of the platter.

46. A platter as claimed in claim 42, wherein the underside of the platter is substantially flat.

47. A platter as claimed in claim 41, further comprising one or more raised edge members around the perimeter of the platter for retaining food debris in use.

48. A platter as claimed in claim 47, comprising one or more raised edge members around the perimeter of both the upper surface and the underside of the platter.

49. A platter as claimed in claim 39, further comprising means for attaching a handle.

50. A platter as claimed in claim 39, further comprising a handle.

51. A platter as claimed in claim 39, made of a polymer material.

52. A platter as claimed in claim 51, wherein the polymer material is a liquid crystal polymer resin reinforced with glass.

53. A platter as claimed in claim 52, made of DuPont (RTM) Zenite (RTM) 7130.

54. A platter as claimed in claim 39, for use in a forced air/microwave combination oven.

55. A platter having a first major surface and a second major surface, the surface area of the first major surface being greater than that of the second major surface so as to concentrate heat flux from the first major surface to the second major surface in use.

56. A platter as claimed in claim 55, wherein the first major surface is ridged or convoluted and the second major surface is substantially flat.

57. An oven having a platter as claimed in claim 39.

58. A method of cooking using an oven having a platter as claimed in claim 39.
